(19) United States
(12) Patent Application Publication
(10) Pub. No.: US 2022/0315871 A1
(43) Pub. Date: Oct. 6, 2022

(54) METHOD OF PRODUCING PLANT EXTRACT-ENRICHED CONSUMABLE ALCOHOL

(71) Applicant: GEORGE STANTCHEV, PHOENIX, AZ (US)

(72) Inventor: GEORGE STANTCHEV, PHOENIX, AZ (US)

(21) Appl. No.: 17/847,797

(22) Filed: Jun. 23, 2022

Related U.S. Application Data
(62) Division of application No. 16/946,852, filed on Jul. 9, 2020.

(51) Int. Cl. C12G 3/055; C12H 3/00

(52) U.S. Cl. CPC C12G 3/055; C12H 3/00

(57) ABSTRACT

A method of producing plant extract-enriched consumable alcohol includes steps of: providing a plant extract; providing a first diluting agent, wherein a purity of the first diluting agent is more than 99 vol %; mixing the plant extract and the first diluting agent to form a mixture; providing a second diluting agent; and mixing the mixture and the second diluting agent to form a plant extract-enriched consumable alcohol; wherein one of the first diluting agent and the second diluting agent is alcoholic and the other one is non-alcoholic, and an alcohol content of the plant extract-enriched consumable alcohol is less than 50 vol %.

### REFERENCE TO RELATED APPLICATIONS

This application is a divisional application of U.S. non-provisional application Ser. No. 16/946,852, filed Jul. 9, 2020, which claims priority claim under 35 U.S.C. § 119(a) on U.S. Provisional Patent Application No. 62/846,723 filed May 12, 2019, the contents each of which are hereby incorporated by reference in their entirety into this application.

### TECHNICAL FIELD

The present disclosure relates to a plant extract-enriched consumable alcohol and a method for manufacturing plant extract-enriched consumable alcohol, more particularly, to a plant extract-enriched consumable alcohol and a method for manufacturing the same that are capable of maintaining a precise content of non-psychoactive cannabinoid in the consumable alcohol.

### BACKGROUND

Cannabis plants may contain or produce up to hundreds of compounds, some of which are active ingredients that affect people mentally or/and physically, known as cannabinoids. The well-known cannabinoids include tetrahydrocannabinol (THC), cannabidiol (CBD), cannabigerol (CBG), cannabichromene (CBC), cannabidivarin (CBDV) and cannabinol (CBN), and these cannabinoids have been proven to have medical benefits in different areas.

Non-psychotropic cannabinoids in specific can help with alcohol tolerance and attenuation of symptoms caused by over drinking, like nausea, vomiting, gastrointestinal tract distress and headaches, and CBD is currently the most popular non-psychoactive cannabinoid. Other known cannabinoids that have non-psychoactive effect are CBN, CBDV, CBG and CBC, etc.; all of those will be referred as cannabinoids deriving mainly from industrial hemp or other plants.

Thus, a drink combining ethanol and CBD would provide relaxation which consumers are looking for in alcohol but less the negative effects of alcohol consumption such as headache, nausea, and gastrointestinal tract distress.

Looking at prior art in this area, U.S. Pat No. 9,539,295 Bohus discloses an alcoholic drink that includes by weight about ninety-nine point nine-two percent (99.92%) ethanol in a liquid state and by weight about zero point zero eight percent (0.08%) cannabinoid in a liquid state. This art does not refer to how the solution becomes a consumable alcohol, nor does this art address how the drink would be delivered in a form for a human consumption without losing the stability of the added cannabinoids.

Further, in the prior art U.S. Pat Nos. 9,642,884 and 10,085,965, Skuratovich et al. describe cannabinoid alcoholic drinks (CADs) and methods for producing CADs, wherein cannabinoids, such as cannabidiol (CBD), are dissolved in ethanol and the resulting cannabinoid/ethanol solution is then combined with one or more consumable alcohols to create a CAD. The art addresses a dilution of cannabinoids in highly concentrated ethanol and adding those into spirits that are 40-50% alcohol by volume but does not treat issues of filtering, moisturizing and softening the spirit, which will filter off the added cannabinoids.

Hence, what is needed is a consumable alcohol enriched with plant extract at a precise concentration that helps to mitigate the negative effects of alcohol consumption upon the human consumer; these negative effects can include but are not limited to nausea, vomiting, headaches, impaired sensory and motor function, slowed cognition, stupefaction, unconsciousness, nervous system depressant, etc. as well as alcohol-accelerated skin problems, asthma, and other problems related to the release of histamine for certain individuals reaction to alcohol.

### SUMMARY

It is well known in the art that the cannabinoid oils do not dilute well in ethanol concentrations less than 90% by volume. It is impossible to achieve proper concentrations of CBD when the CBD is directly diluted in alcohol for human consumption at around 40% by volume. Therefore, the dilution of the cannabinoids has to happen at the high concentrated state or in the use of an agent. In order to preserve highest purity of the mixture, both agents have to achieve its maximum concentration and purity of around 90% to 99.99% by volume (90 vol % to 99.99 vol %).

An object of the present disclosure is to provide a plant extract-enriched consumable alcohol for human consumption and a manufacturing method of the plant extract-enriched consumable alcohol. The plant extract-enriched alcohol composition includes obtaining a high quality pure ethanol at about ninety to ninety-nine point nine-nine percent (90 vol %-99.99 vol %) and mixing it with an about eighty to ninety-nine point nine-nine percent (80 vol %-99.99 vol %) pure cannabinoid before diluting the mixture to a consumable level.

Therefore, it is an object of the present disclosure to provide a plant extract-enriched consumable alcohol that includes a plant extract, a first diluting agent, and a second diluting agent. The first diluting agent has a purity of more than 90 vol %, preferably 99 vol %, and is mixed with the plant extract to form a mixture. The second diluting agent is mixed with the mixture to form the plant extract-enriched consumable alcohol. One of the first diluting agent and the second diluting agent is alcoholic and the other one is non-alcoholic, and an alcohol content of the plant extract-enriched consumable alcohol is less than 50 vol %, and preferably 40 vol %.

Optionally, the plant extract is a non-psychotropic cannabinoid and has a purity of between 30 vol % and 100 vol %, preferably in the range of 80 vol % to 100 vol % and best at around 99.9 vol %.

Optionally, a concentration of the non-psychotropic cannabinoid in the plant extract-enriched consumable alcohol is between 0.01 wt % and 0.15 wt % or 50 mg to 1000 mg of the non-psychotropic cannabinoid in 1 L of the plant extract-enriched consumable alcohol. One of the best concentrations is 0.015 wt % in the consumable alcohol or 100 mg active ingredient (non-psychotropic cannabinoid) in 750 mL of the consumable alcohol (plant extract-enriched consumable alcohol).

Optionally, the first diluting agent is ethanol and the purity of the ethanol is 99.99 vol %. The 99.99 vol % of ethanol has a weight of 789 g/L.

Optionally, the concentration of non-psychotropic cannabinoid in the plant extract-enriched consumable alcohol is 0.02 wt % or 200 mg/L in consumable alcohol. Consumable alcohol at 40 vol % concentration is 915.6 g weight per 1 liter used for the base of such dilution.

Optionally, the alcohol content of the plant extract-enriched consumable alcohol is 40 vol %. The remaining 60% of the plant extract-enriched consumable alcohol is distilled water.

Optionally, a composition of the mixture includes: by weight 90 wt % to 99.98 wt % ethanol and by weight 0.02 wt % to 0.15 wt % non-psychotropic cannabinoid.

Optionally, the first diluting agent is humectant and the purity of the humectant is approximately 99.99 vol %.

Optionally, the second diluting agent is a filtered alcohol and an alcohol content of the filtered alcohol is less than 50 vol %, preferably at 40 vol %.

Another object of the present disclosure is to provide a method of producing plant extract-enriched consumable alcohol, and the method includes the steps of: providing a plant extract; providing a first diluting agent having a purity of more than 99 vol %; mixing the plant extract and the first diluting agent to form a mixture; providing a second diluting agent; and mixing the mixture and the second diluting agent to form a plant extract-enriched consumable alcohol. One of the first diluting agent and the second diluting agent is alcoholic and the other one is non-alcoholic, and an alcohol content of the plant extract-enriched consumable alcohol is less than 50 vol %.

Optionally, the first diluting agent is ethanol, the second diluting agent is non-alcoholic, and the step of providing a first diluting agent includes refining the first diluting agent to a purity of 99.99 vol %.

Optionally, the step of refining the first diluting agent includes distilling the first diluting agent at least 5 times, preferably 7 times.

Optionally, the step of mixing the plant extract and the first diluting agent includes emulsifying the mixture.

Optionally, the first diluting agent is humectant, the second diluting agent is ethanol, and the step of providing the second diluting agent includes: diluting the second diluting agent to obtain the alcohol content of less than 50 vol %; and filtering the second diluting agent with the less than 50 vol % alcohol content.

Optionally, the first diluting agent is humectant and the second diluting agent is a distilled spirit.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a flow chart of a method for manufacturing plant extract-enriched consumable alcohol according to an embodiment of the present disclosure.

FIG. 2 is a flow chart of a method for manufacturing plant extract-enriched consumable alcohol according to another embodiment of the present disclosure.

FIG. 3 is a flow chart of a method for manufacturing plant extract-enriched consumable alcohol according to yet another embodiment of the present disclosure.

FIG. 4 illustrates a process of manufacturing plant extract-enriched consumable alcohol according to an embodiment of the present disclosure.

### DETAILED DESCRIPTION OF THE PREFERRED EMBODIMENTS

A Cannabinoid is a high concentrated plant extract from Cannabis sativa or indica, which is more often obtained from the flower, less from the leaves and some from the stock, root and stems, that contains multiple ingredients derived from the plant itself. Usually the raw form of this extract contains about 10 vol % terpenes, 80 vol % mix of cannabinoids as CBD, CBN, CBG, CBDV, THC, etc. in their acid and phenolic form and 10 vol % of lipid oils and other compounds per the total volume of the extract. More specifically, among three main categories by the type of constituents the cannabis extracts maintain, terpenes are essential oils with no or little cannabinoids of less than 10 vol %, cannabinoids are plant resins with 30-97 vol % total cannabinoid content, and isolates are isolated 97 to 100 vol % pure cannabinoids. When pure cannabinoid oil is addressed, it is commonly referenced in a form of a hemp extract (30 vol % purity), concentrate (70 vol % purity), distillate (85 vol % purity) and all the way to isolate (100 vol % purity), wherein the percentage refers to the purity of cannabinoid in such form by the volume of the oil. The 100 vol % oil purity means that the concentration is plant derived and do not allow non-hemp derived constituents. The concentration of plant derived constituents will be further addressed as cannabinoid or the “active” ingredient or the plant extract.

The present disclosure is of a plant-enriched consumable alcohol for human consumption and a method to manufacture the plant-enriched consumable alcohol. The plant extract-enriched consumable alcohol includes a consumable alcohol drink, preferably of 40 vol % alcohol content, enriched with a plant extract like cannabidiol, wherein the plant extract is from 50 mg to 1000 mg per volume of the consumable substance and more specifically between 0.01 wt % and 0.15 wt %, in which the most preferred concentration is 0.015 to 0.02 wt % per volume. The starting raw cannabidiol with initial concentration of 30 vol % to 100 vol %, preferably 80 vol % to 100 vol %, purity is diluted with multiple times distilled pure alcohol (90 vol % to 99.9 vol % ethanol) in a liquid state and then the cannabidiol/ethanol mixture is further diluted down to a consumable concentration of less than 50 vol % alcohol content, preferably 40 vol % alcohol content.

In one embodiment, the plant extract-enriched consumable alcohol preferably includes a mixture and a diluent, wherein the mixture is by weight about ninety-nine point nine-eight percent (99.98 wt %) ethanol in a liquid state and by weight about zero point zero two percent (0.02 wt %) cannabinoid in a liquid state and the ratio of the mixture to the diluent is less than 1. Moreover, the most preferred cannabinoid concentration in the plant extract-enriched consumable alcohol is 200 mg/Liter and less preferred is 500 mg/Liter and 1000 mg/Liter.

In addition, the composition of the mixture in the plant extract-enriched consumable alcohol in the weight percentage is that the ethanol can be from ninety percent (90 wt %) to up to about ninety-nine point nine-eight percent (99.98 wt %) by weight and the cannabinoid/cannabidiol can be about zero point zero two percent (0.02 wt %) up to zero point one five (0.15 wt %) by weight, preferably 99.95 wt % to 99.98 wt % of ethanol and 0.02 wt % to 0.05 wt % of cannabinoid. And as the mixture is diluted to 40 vol % alcohol content, the cannabinoid/cannabidiol will be present in 0.02 wt % or 150 mg per 750 ml bottle, or alternatively 0.015 wt % or 100 mg per 750 ml bottle.

The plant extract-enriched consumable alcohol is made by providing the ethanol in a liquid state with between 90 vol % to a 100 vol %, preferably 99 vol %, concentration and distilling the pure ethanol before mixing the cannabinoid, preferably in the form of a cannabidiol oil and in a 99 vol % pure form, to the concentrated pure ethanol. The mixture is subsequently agitated until the cannabidiol oil and the ethanol are in a substantially emulsified state with one another and then diluted with a diluent or a pure diluting agent, such as water, to form a consumable alcohol concentration of less than 50 vol % alcohol content.

In many quality alcoholic drinks, a secondary purification of the ethanol is required, such as but not limited to, filtering using sand, carbon, silica gel, earth compounds or other absorbers. When post purification processing is required, the purification is done on the highly concentrated spirit and then the purified spirit is mixed with the active ingredients before being diluted to volume with a proper diluent like distilled water. However, if the purification is done on the mixed alcoholic drink, the active ingredients, in this case the cannabinoids, may be absorbed by the absorbers during the filtering process and thus the cannabinoid content in the end product is uncertain and reduced. In such case, the dilution/mixing of the active ingredients is done by use of humectants.

Furthermore, if taste stabilization is required or the alcoholic mixture is filtered at consumer concentration, a humectant can be used to introduce the active substance/ingredient/agent. In the food industry, humectants can be used to increase the solubility of a chemical compound, increasing the active ingredients' bioavailability. There are many forms of humectants, for example: propylene glycol, hexylene glycol, and butylene glycol, aloe vera gel, alpha hydroxy acids such as lactic acid, egg yolk and egg white, glyceryl triacetate, glycerol, honey, some lipid oils, etc.

Since the active agent does not dilute well in consumable alcohol with alcohol concentrations below 50% by volume (50 vol %), it can be introduced after the distillation, emulsification and purification process when diluting in humectant like glycerol, which is also called glycerine or glycerin. It is a colorless, odorless, viscous liquid that is sweet-tasting and non-toxic. Glycerol has three hydroxyl groups that are responsible for its solubility in water and its hygroscopic nature which makes it one of the best candidates for introducing agents.

Adding the active substance (in this case the active agent) and mixing it with the diluted consumable alcohol is the only way the active agent can be introduced with the correct concentration to the consumable alcohol after the distillation and filtration is completed.

Hence, in another embodiment, the ethanol is distilled multiple times and diluted down to below 50 vol % alcohol content and filtered through multiple charcoal passes so as to make a consumable alcohol. The starting raw cannabidiol with initial concentration of 30 vol % to 100 vol % purity is diluted with humectant agent with 90 vol % to 99.99 vol % purity, for example propylene glycol, glycerin or similar, for softening or taste stabilizing, and then the mixture of cannabidiol and humectant is added to the consumable alcohol to form the plant extract-enriched consumable alcohol.

As described above, the cannabinoid is preferably a cannabidiol oil, however, other cannabinoids could also be used in the mixture. Further, for the mixture of the plant extract-enriched consumable alcohol, the cannabinoid or the cannabidiol oil can alternatively be selected from the group consisting of plant based, synthetic based, and/or a combination of plant plus synthetic based.

To sum up, the plant extract-enriched consumable alcohol of the present disclosure includes a plant extract, a first diluting agent, and a second diluting agent. The plant extract is a non-psychotropic or non-psychoactive cannabinoid having a purity of 30 vol % to 100 vol %. The first diluting agent has a purity of more than 90 vol %, preferably 99 vol % and is mixed with the plant extract to form a mixture, wherein the first diluting agent is ethanol or humectant. The second diluting agent is mixed with the mixture to form the plant extract-enriched consumable alcohol having an alcohol content of less than 50 vol %, wherein one of the first diluting agent and the second diluting agent is alcoholic and the other one is non-alcoholic.

The concentration of the non-psychotropic cannabinoid in the plant extract-enriched consumable alcohol is between 0.01 wt % and 0.15 wt % or 50 mg to 1000 mg of the non-psychotropic cannabinoid in 1 L of the plant extract-enriched consumable alcohol. Preferably, the plant extract-enriched consumable alcohol has a non-psychotropic cannabinoid concentration of 0.029 wt % or 200 mg/L and an alcohol content of 40 vol %. More preferably, the plant extract-enriched consumable alcohol has a non-psychotropic cannabinoid concentration of 0.015 wt % or 100 mg/750 ml and an alcohol content of 40 vol %.

When the first diluting agent is ethanol, the purity of the ethanol is 99.99% and the composition of the mixture is by weight 99.95 wt % to 99.98 wt % ethanol and by weight 0.02 wt % to 0.05 wt % non-psychotropic cannabinoid, or by weight 90 wt % to 99.98 wt % ethanol and by weight 0.02 wt % to 0.15 wt % non-psychotropic cannabinoid.

When the first diluting agent is humectant, the purity of the humectant is 99.99 vol % and the second diluting agent is a filtered alcohol with less than 50 vol % alcohol content.

Next, methods of making high quality hard liquor drink like the plant extract-enriched consumable alcohol of the present disclosure is described.

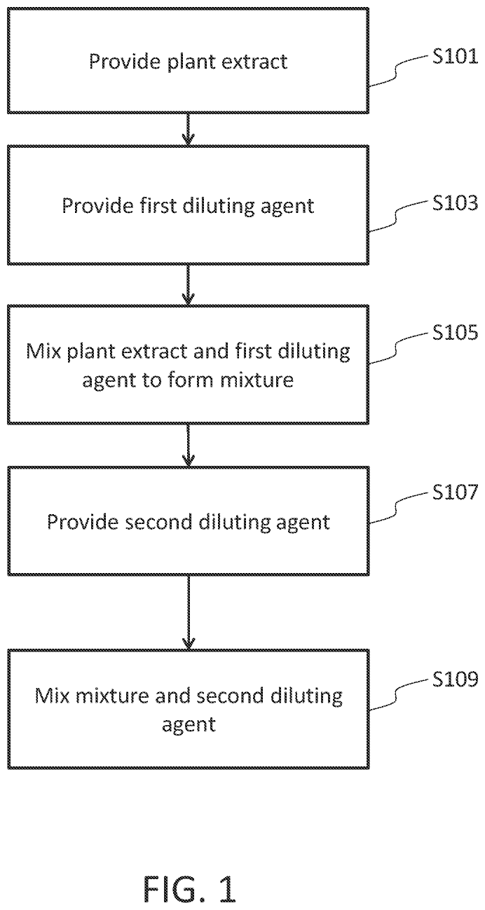

Referring to FIG. 1, which is a flow chart of a method for manufacturing plant extract-enriched consumable alcohol according to an embodiment of the present disclosure, step S101 is to provide a plant extract and step S103 is to provide a first diluting agent. The plant extract is non-psychotropic cannabinoids and is in a solid or liquid state. The first diluting agent has a purity of more than 99 vol % and is in a liquid state, wherein the first diluting agent is, for example but not limited to, ethanol or humectant. Next, in step S105, the plant extract and the first diluting agent are mixed to form a mixture. The mixture is agitated and emulsified, wherein the plant extract and the first diluting agent are in a substantially emulsified state with one another in a liquid state. Then a second diluting agent is provided in step S107 and subsequently the mixture of the plant extract and the first diluting agent is mixed with the second diluting agent to form the plant extract-enriched consumable alcohol in step S109. The second diluting agent is, for example but not limited to, an alcoholic liquid like a consumable alcohol, or a non-alcoholic liquid like water, wherein one of the first diluting agent and the second diluting agent is alcoholic and the other one is non-alcoholic. It is to be noted that the sequence of steps S101 and S103 can be changed so long as the first diluting agent and the plant extract are provided before mixing in step S105; the present disclosure is not limited thereby.

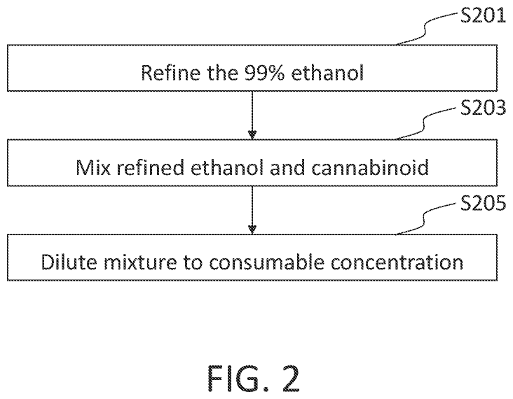

FIG. 2 is a flow chart of a method for manufacturing plant extract-enriched consumable alcohol according to another embodiment of the present disclosure, wherein the plant extract is non-psychotropic cannabinoid like cannabidiol oil (CBD), the first diluting agent is ethanol, and the second diluting agent is non-alcoholic liquid such as, but not limited to, distilled water or mountain spring water. Referring to FIG. 2, step S201 is providing the ethanol in a liquid state and refining the ethanol. A highly concentrated distilled ethanol at around 90 vol % to 99 vol % concentration is provided and for producing high quality spirits, such ethanol is additionally distilled multiple times, for example 5 times and preferably 7 times, to achieve over 99.99 vol % desired food grade purity.

In step S203, the refined ethanol and the cannabinoid are mixed and combined to form a mixture with initial concentrate. In particular, the cannabinoid or the cannabidiol oil (CBD) is mixed with the distilled and purified ethanol with the desired concentrations and the mixture is agitated until the cannabidiol oil and the ethanol are in a substantially emulsified state with one another in a liquid state. For example, if the target composition for the plant extract-enriched consumable alcohol is 150 mg CBD per 750 ml of 40 vol % alcohol, the concentration of CBD mixed with the 99.99 vol % pure ethanol should be 500 mg per liter, wherein it must be considered that 789 g of 99.9% alcohol is in 1 L volume. This will constitute 0.05 wt % CBD concentration in the pure spirit/the mixture.

Finally, the mixture is diluted to a consumable concentration in step S205, wherein a pure diluent, namely the second diluting agent, is added, such as but not limited to, distilled and filtered mountain spring water, etc. In this process, further filtering is not recommended as that will affect the concentration of the active ingredients in the oil. To achieve the target composition, the dilution is to 40 vol % alcohol and the CBD concentration will decrease to 0.029 wt % or 150 mg CBD per 750 ml 40 vol % alcohol, wherein the 750 ml of 40% alcohol is 686.7 g (1 L of 40% alcohol is 915.6 g).

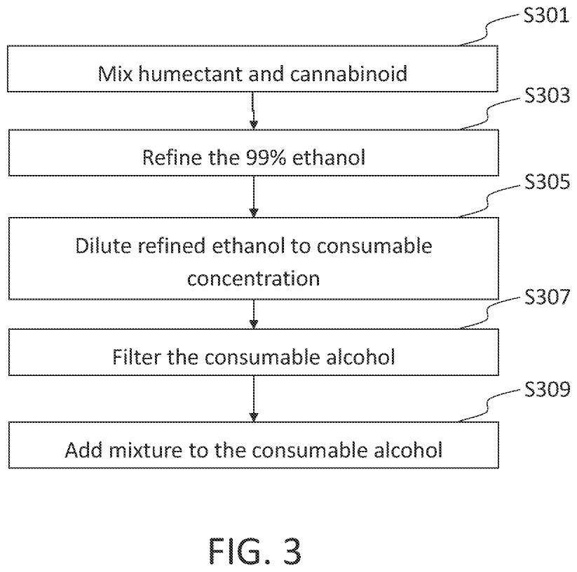

FIG. 3 is a flow chart of a method for manufacturing plant extract-enriched consumable alcohol according to yet another embodiment of the present disclosure, wherein the plant extract is non-psychotropic cannabinoid like cannabidiol oil (CBD), the first diluting agent is humectant, and the second diluting agent is consumable alcohol. Referring to FIG. 3, step S301 is to mix the humectant and the cannabinoid (CBD) to form a mixture; in other words, the plant extract and the first diluting agents are provided and mixed together. The CBD is mixed with a proper humectant agent, such as glycerin, polypropylene glycol and similar as explained with proper proportions.

In step S303, a highly concentrated distilled ethanol at around 90 vol % to 99 vol % concentration is provided and refined. As explained above, such ethanol is additionally distilled multiple times like, but not limited to, 5 or 7 times to achieve over 99.99 vol % food grade purity. Next, the refined ethanol is diluted to a consumable concentration in step S305 by adding a pure diluent, such as distilled and filtered mountain spring water, etc., to form a consumable alcohol. The dilution is usually for achieving alcohol concentration of less than 50 vol %, preferably 40 vol %.

The diluted consumable alcohol is then passed through a set of filters to filter the impurities in step S307. The filters can construe a series of passes through sand, carbon, silica, various earth compounds, etc. or a combination of those. Such consumable alcohol is usually filtered multiple times, for instance 5 times, for achieving desired neutral taste. Steps S303 to S307are steps that provide and/or prepare the second diluting agent for subsequent mixing with the CBD/humectant mixture.

Step S309 is adding the mixture of CBD and humectant to the filtered consumable alcohol, namely the second diluting agent, to form the plant extract-enriched consumable alcohol, wherein the mixture is mixed with the filtered/purified consumable alcohol and the two are emulsified. More particularly, the mixture is added to the filtered/purified consumable alcohol with the desired concentration and the mix of the mixture and the filtered/purified consumable alcohol is emulsified. The proper proportion is calculated based on a humectant concentration in the alcohol as example 1 g per 1 L humectant will constitute mixing 200 mg pure CBD with 1000 mg humectant to achieve 150 mg CBD concentration in 750 ml bottle.

It is to be noted that step S301 can be performed after or between steps S303 and S307 but must be performed before step S309, so that the CBD/humectant mixture from step S301 is ready to be mixed with the consumable alcohol prepared by steps S303 to S307 in step S309; the present disclosure is not limited thereby.

There are 2 types of consumable alcohol that can be made: engineered spirit and distilled spirit. The engineered alcohols can be any alcoholic drink that contains 99 vol % alcohol diluted in substance that can be water or other consumable mixture as example coladas, lemonades, fruit mixes, etc. An example for engineered alcoholic beverages are vodka, gin, ouzo, ice drinks, with concentration of the spirits being below 50 vol % consumable level and ranging from around 0.4 vol % to 50 vol % etc. The distilled spirits are all naturally derived fermented mixtures that are distilled and possibly aged, for example, brandy, whiskey, cognac, etc.

The method of adding an active agent/substance/ingredient to an engineered drink made from pure alcohol and diluted down to a consumable concentration has been disclosed in FIG. 2 and FIG. 3, by which the plant extract-enriched consumable alcohol made can be vodka, gin, ouzo, tequila, brandy, etc. or an engineered alcohol that starts from 99 vol % food grade alcohol in general. However, applying active agent/substance/ingredient to any consumable alcohol would require a more detailed method. A complete method can be established for applying to any consumable alcohol whether it is engineered or aged.

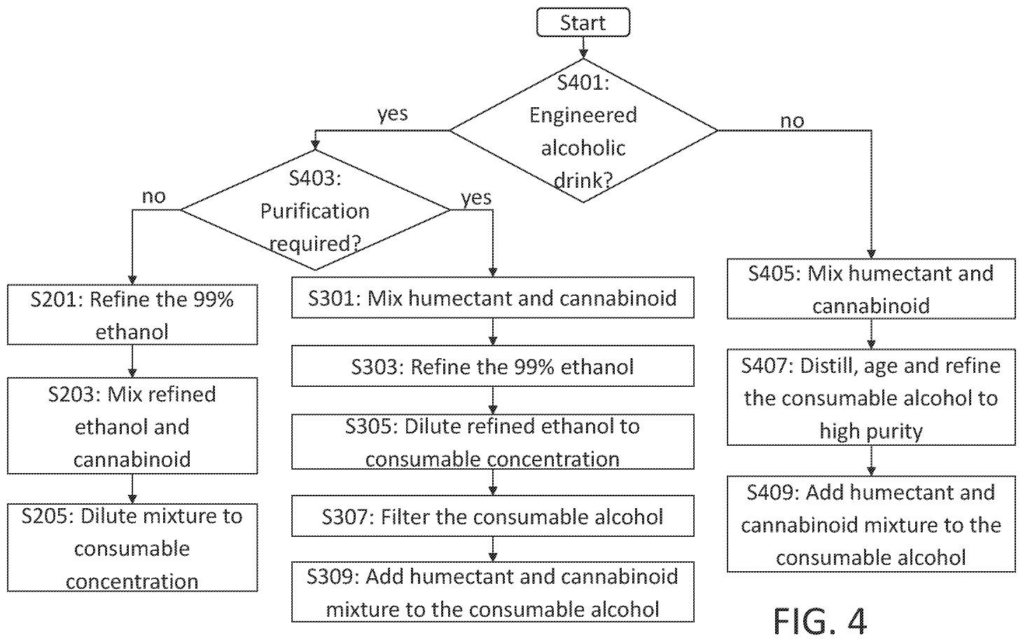

In FIG. 4, a complete method for adding an active agent/plant extract to a consumable alcohol is shown. First, determine that whether the alcoholic beverage to be made is an engineered or a distilled drink in step S401. If the drink is engineered, proceed to step S403 to determine whether purification is required. If purification is not required, proceed to steps S201 to S205, which are the method steps in FIG. 2, and if purification is required, proceed to steps S301 to S309, which are the method steps in FIG. 3.

If the consumable alcohol to be made is not an engineered drink, then there will not be a 99 vol % pure alcohol stage in the process and steps S405 to S409 are executed. In this case, the plant extract is cannabinoid extract, the first diluting agent is humectant, and the second diluting agent is a consumable alcohol or an alcoholic drink. Step S405 is to mix the humectant and the cannabinoid extract to form the mixture, and since the consumable alcohol, like the distilled or aged spirit, is already at a consumable level, instead of refining the alcohol and diluting it to a consumable concentration, the next step in S407 is simply finding the distilled alcoholic drink in already distilled and prepared consumable concentration which can be additionally filtered or refined to meet purity. In specific, the alcoholic drink is distilled as consumable alcohol and filtered to higher purity or aged. Then step S409 is adding the mixture to the consumable alcohol and mixing the two to form the plant extract-enriched consumable alcohol.

It is to be noted that if the consumable alcohol does not need further purification, step S407 can be skipped, and if the alcoholic drink requires further distillation/filtering, steps S407 and S405 can be performed in different order as long as the consumable alcohol and the CBD/humectant mixture are ready for mixing in step S409; the present disclosure is not limited thereby.

In view of the above, the present disclosure provides a plant extract-enriched consumable alcohol and method for producing the same, wherein the plant extract is mixed with highly concentrated diluent to ensure it is or it would be well diluted before being added to a pure diluent to form the plant extract-enriched consumable alcohol. In comparison to the conventional cannabinoid alcoholic drink and manufacturing method, the consumable alcohol and manufacturing method of the present disclosure allows the plant extract to be fully diluted in a consumable alcohol of any kind and maintains the precise concentration of plant extract in the plant extract-enriched consumable alcohol, and the specific concentration ranges defined are optimal both in effects and tastes. For instance, having more than 1000 mg of CBD per volume in an alcohol drink would have some side effects to the product.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

What is claimed is:

1. A method of producing plant extract-enriched consumable alcohol, the method comprising:
providing a plant extract;
providing a first diluting agent, wherein a purity of the first diluting agent is more than 99 vol %;
mixing the plant extract and the first diluting agent to form a mixture;
providing a second diluting agent; and
mixing the mixture and the second diluting agent to form a plant extract-enriched consumable alcohol;
wherein one of the first diluting agent and the second diluting agent is alcoholic and the other one is non-alcoholic, and an alcohol content of the plant extract-enriched consumable alcohol is less than 50 vol %.

2. The method of claim 1, wherein the plant extract is a non-psychotropic cannabinoid and a purity of the non-psychotropic cannabinoid is between 30 vol % and 100 vol %.

3. The method of claim 2, wherein the first diluting agent is ethanol, the second diluting agent is non-alcoholic, and the step of providing a first diluting agent comprises refining the first diluting agent to a purity of 99.99 vol %.

4. The method of claim 3, wherein the step of refining the first diluting agent comprises distilling the first diluting agent at least 5 times.

5. The method of claim 4, wherein the step of refining the first diluting agent comprises distilling the first diluting agent 7 times.

6. The method of claim 3, wherein a composition of the mixture comprises: by weight 90 wt % to 99.98wt % ethanol and by weight 0.02 wt % to 0.15 wt % non-psychotropic cannabinoid.

7. The method of claim 1, wherein the first diluting agent is humectant, the second diluting agent is ethanol, and the step of providing the second diluting agent comprises: diluting the second diluting agent to obtain the alcohol content of less than 50 vol %; and filtering the second diluting agent with the less than 50 vol % alcohol content.

8. The method of claim 1, wherein the first diluting agent is humectant and the second diluting agent is a distilled spirit.
